(19) United States
(12) Patent Application Publication
(10) Pub. No.: US 2026/0329467 A1
(43) Pub. Date: Oct. 22, 2026

(54) MEMORY DATA MIGRATION METHOD AND APPARATUS, ELECTRONIC DEVICE, AND STORAGE MEDIUM

(71) Applicant: SUZHOU METABRAIN INTELLIGENT TECHNOLOGY CO., LTD., Jiangsu (CN)

(72) Inventors: Yaqian ZHAO, Jiangsu (CN); Fang CAO, Jiangsu (CN); Zhenhua GUO, Jiangsu (CN); Li WANG, Jiangsu (CN); Kai GAO, Jiangsu (CN)

(73) Assignee: SUZHOU METABRAIN INTELLIGENT TECHNOLOGY CO., LTD., Jiangsu (CN)

(21) Appl. No.: 19/116,791

(22) PCT Filed: Aug. 2, 2024
(86) PCT No.: PCT/CN2024/109618

§ 371 Date: Mar. 28, 2025

(30) Foreign Application Priority Data
Aug. 4, 2023 (CN) 202310975510.X

(51) Int. Cl. G06F 3/06

(52) U.S. Cl. CPC G06F 3/0647; G06F 3/0614; G06F 3/0673

(57) ABSTRACT

A memory data migration method and apparatus, an electronic device, and a storage medium are provided. The method is applied to a hierarchical memory system which includes a plurality of memory nodes corresponding to different hierarchies. The method includes: determining a target memory page to be migrated to a target memory node; determining an idle page in the target memory node, and migrating the target memory page to the idle page; and when it is detected that the number of remaining idle pages in the target memory node is less than a preset threshold, continuously migrating inactive memory pages in the target memory node to other memory nodes having a hierarchy lower than the target memory node until it is determined that the number of idle pages is not less than the preset threshold.

### CROSS-REFERENCE TO RELATED APPLICATION

The present disclosure claims the priority to Chinese Patent Application No. 202310975510.X, filed on Aug. 4, 2023 to the China National Intellectual Property Administration and entitled “MEMORY DATA MIGRATION METHOD AND APPARATUS, ELECTRONIC DEVICE, AND STORAGE MEDIUM”, which is incorporated herein by reference in its entirety.

### TECHNICAL FIELD

The present disclosure relates to the technical field of hierarchical memories, and in particular, to a memory data migration method and apparatus, an electronic device, and a non-transitory readable storage medium.

### BACKGROUND

A hierarchical memory technology is an emerging memory technology. This technology allows a hierarchical memory system to be provided in an electronic device, wherein the system includes a plurality of memory nodes, and these memory nodes correspond to different hierarchies. At the same time, this technology uses a non-uniform memory access (NUMA) framework to uniformly manage these memory nodes, thereby integrating the advantages of various types of memory devices. In the related art, to enable an application program to run with high performance, a memory page required by the program is typically migrated to a target memory node with better performance. However, in the case where the target memory node is overwritten, the migration of the memory page will fail, thereby affecting the efficient reading of the application program.

### SUMMARY

An object of the present disclosure is to provide a memory data migration method and apparatus, an electronic device, and a non-transitory readable storage medium.

The present disclosure provides a memory data migration method, which is applied to a hierarchical memory system, wherein the hierarchical memory system includes a plurality of memory nodes corresponding to different hierarchies; and the method includes:
a target memory page to be migrated to a target memory node is determined;
an idle page in the target memory node is determined, and the target memory page is migrated to the idle page; and
when it is detected that the number of remaining idle pages in the target memory node is less than a preset threshold, an inactive memory page in the target memory node is continuously migrated to other memory nodes with a hierarchy lower than the target memory node until it is determined that the number of the idle pages is not less than the preset threshold.

In some embodiments, the inactive memory page in the target memory node is continuously migrated to other memory nodes with the hierarchy lower than the target memory node includes:
a first memory node with a slowest local access speed and a second memory node with a slowest remote access speed are determined from the other memory nodes; and
the inactive memory page in the target memory node is continuously migrated to the first memory node or the second memory node.

In some embodiments, the inactive memory page in the target memory node is continuously migrated to the first memory node or the second memory node includes:
a target inactive memory page to be migrated currently is determined, and it is determined whether the second memory node is overwritten;
in response to the second memory node being not overwritten, the target inactive memory page is migrated to the second memory node;
in response to the second memory node being overwritten, it is determined whether the first memory node is overwritten;
in response to the first memory node being not overwritten, the target inactive memory page is migrated to the first memory node; and
in response to the first memory node being overwritten, it proceeds to the step of determining whether the second memory node is overwritten.

In some embodiments, the inactive memory page in the target memory node is migrated to the second memory node includes:
on the basis of an ultra path interconnect protocol, the inactive memory page in the target memory node is migrated to the second memory node.

In some embodiments, the inactive memory page in the target memory node is migrated to other memory nodes with the hierarchy lower than the target memory node includes:
a preset corresponding relationship between an inactivity degree of a memory page and a hierarchy of a memory node is acquired; and
the inactive memory page is migrated to other memory nodes of corresponding hierarchies according to the preset corresponding relationship and the inactivity degree of the inactive memory page,

In some embodiments, the inactive memory page in the target memory node is continuously migrated to other memory nodes with the hierarchy lower than the target memory node includes:
a memory page with a least access amount within a recent preset time period is set as the inactive memory page;
the inactive memory page is migrated to the other memory nodes, and the number of the idle pages is updated; and
when it is determined that the updated number of the idle pages is less than the preset threshold, it proceeds to the step of setting a memory page with a least access amount within a recent preset time period as the inactive memory page.

In some embodiments, the memory page with the least access amount within the recent preset time period is set as the inactive memory page includes:
the memory page with the least access amount within the recent preset time period is set, using an inactive least recently used linked list, as the inactive memory page.

In some embodiments, the memory page with the least access amount within the recent preset time period is set, using the inactive least recently used linked list, as the inactive memory page includes:
when it is determined that an inactive file page least recently used linked list is not empty, a memory page at a tail of the inactive file page least recently used linked list is set as the inactive memory page; and
when it is determined that the inactive file page least recently used linked list is empty, a memory page at a tail of an inactive anonymous page least recently used linked list is set as the inactive memory page.

In some embodiments, before the target memory page to be migrated to the target memory node is determined, the method further includes:
hierarchies corresponding to the memory nodes are set, according to a target central processing unit where an application program thread is located and an association relationship between the target central processing unit and the memory nodes,.

In some embodiments, hierarchies corresponding to the memory nodes are set, according to the target central processing unit where an application program thread is located and the association relationship between the target central processing unit and the memory nodes, includes:
the hierarchies corresponding to the memory nodes are set, according to the target central processing unit where the application program thread is located and a mounting relationship between the target central processing unit and the memory nodes.

In some embodiments, hierarchies corresponding to the memory nodes are set, according to the target central processing unit where the application program thread is located and the association relationship between the target central processing unit and the memory nodes, includes:
the hierarchies corresponding to the memory nodes are set, according to the target central processing unit where the application program thread is located and a speed of the target central processing unit to read and write the memory nodes.

In some embodiments, after the hierarchies corresponding to the memory nodes are set, the method further includes:
a memory node with a highest hierarchy is set as the target memory node.

In some embodiments, the target memory page to be migrated to the target memory node is determined includes:

when it is determined that a memory page requested to be accessed by the application program thread is not saved in the target memory node, the memory page requested to be accessed by the application program thread is set as the target memory page.

In some embodiments, after the target memory page is migrated to the idle page, the method further includes:
data in the target memory page is returned to the application program thread.

In some embodiments, a storage space of the target memory node includes a general space and a reserved space, wherein the general space is maintained by an automatic non-uniform memory access framework; and the idle page in the target memory node is determined, and the target memory page is migrated to the idle page includes:
the target memory page is migrated, using the automatic non-uniform memory access framework, to the general space, and it is determined whether the automatic non-uniform memory access framework outputs page fault information; and
an idle page in the reserved space is determined, in response to the automatic non-uniform memory access framework having output the page fault information,, and the target memory page is migrated to the idle page in the reserved space; and
accordingly, when it is detected that the number of remaining idle pages in the target memory node is less than a preset threshold, the inactive memory page in the target memory node is continuously migrated to other memory nodes with a hierarchy lower than the target memory node until it is determined that the number of the idle pages is not less than the preset threshold includes:
when it is detected that the number of remaining idle pages in the reserved space is less than the preset threshold, the inactive memory page in the target memory node is continuously migrated to the other memory nodes with the hierarchy lower than the target memory node, and a reclaimed idle page is replenished to the reserved space until it is determined that the number of the idle pages in the reserved space is not less than the preset threshold.

In some embodiments, the target memory page is migrated to the idle page in the reserved space includes:
a location of the target memory page is determined, according to the page fault information; and
the target memory page is migrated to the idle page in the reserved space, according to the location.

In some embodiments, the idle page in the reserved space is determined, and the target memory page is migrated to the idle page in the reserved space includes:
the idle page in the reserved space is determined, using a first preset thread, and the target memory page is migrated to the idle page in the reserved space; and
accordingly, the inactive memory page in the target memory node is continuously migrated to the other memory nodes with the hierarchy lower than the target memory node, and a reclaimed idle page is replenished to the reserved space includes:
the inactive memory page in the target memory node is continuously migrated to the other memory nodes, using a second preset thread, and the reclaimed idle page is replenished to the reserved space.

In some embodiments, the method further includes:
the second preset thread is waked up using the first preset thread, when the first preset thread determines that the number of the remaining idle pages in the reserved space is less than the preset threshold.

In some embodiments, the method further includes:
the second preset thread is hibernated when it is determined that the number of the idle pages in the reserved space is not less than the preset threshold,

The present disclosure further provides a memory data migration apparatus, which is applied to a hierarchical memory system, wherein the hierarchical memory system includes a plurality of memory nodes corresponding to different hierarchies; and the apparatus includes:
a target memory page determination module, configured to determine a target memory page to be migrated to a target memory node;
a migration module, configured to determine an idle page in the target memory node, and migrate the target memory page to the idle page; and
a downgrading module, configured to continuously migrate, when it is detected that the number of remaining idle pages in the target memory node is less than a preset threshold, an inactive memory page in the target memory node to other memory nodes with a hierarchy lower than the target memory node until it is determined that the number of the idle pages is not less than the preset threshold.

The present disclosure further provides an electronic device, including:
a memory, configured to store a computer program; and
a processor, configured to implement, when executing the computer program, the memory data migration method as described above.

The present disclosure further provides a non-transitory computer readable storage medium storing therein a computer-executable instruction that, when loaded and executed by a processor, implements the memory data migration method as described above.

The present disclosure provides a memory data migration method, which is applied to a hierarchical memory system, wherein the hierarchical memory system includes a plurality of memory nodes corresponding to different hierarchies. The method includes: determining a target memory page to be migrated to a target memory node; determining an idle page in the target memory node, and migrating the target memory page to the idle page; and when it is detected that the number of remaining idle pages in the target memory node is less than a preset threshold, continuously migrating an inactive memory page in the target memory node to other memory nodes with a hierarchy lower than the target memory node until it is determined that the number of the idle pages is not less than the preset threshold.

### BRIEF DESCRIPTION OF THE DRAWINGS

In order to illustrate the embodiments of the present disclosure or the technical solutions in the prior art more clearly, a brief introduction will be made to the drawings used in the description of the embodiments or the prior art. Apparently, the drawings in the description below only show the embodiments of the present disclosure, and a person of ordinary skill in the art can obtain other drawings according to these drawings without creative work.

FIG. 1 is a diagram of a hierarchical memory system according to an embodiment of the present disclosure;

FIG. 2 is a flowchart of a first memory data migration method according to an embodiment of the present disclosure;

FIG. 3 is a flowchart of a second memory data migration method according to an embodiment of the present disclosure;

FIG. 4 is a flowchart of a third memory data migration method according to an embodiment of the present disclosure;

FIG. 5 is a structural block diagram of a memory data migration apparatus according to an embodiment of the present disclosure; and

FIG. 6 is a structural block diagram of an electronic device according to an embodiment of the present disclosure.

### DETAILED DESCRIPTION OF THE EMBODIMENTS

To make the object, technical solution, and advantages of the embodiments of the present disclosure clearer, the technical solution in the embodiments of the present disclosure is described clearly and completely with reference to the drawings in the embodiments of the present disclosure. Apparently, the described embodiments are a part of, but not all of, the embodiments of the present disclosure. All other embodiments obtained by a person of ordinary skill in the art on the basis of the embodiments in the present disclosure without creative work shall fall within the scope of protection of the present disclosure.

For ease of understanding, a brief introduction of a hierarchical memory system applicable to the present disclosure is first provided. Referring to FIG. 1, FIG. 1 is a diagram of a hierarchical memory system according to an embodiment of the present disclosure. The hierarchical memory system may generally include a plurality of memory nodes. For example, the system shown in FIG. 1 includes two processors and four memory nodes, wherein the processor 0 is configured to mount the dynamic random access memory (DRAM) 0 and the persistent memory (PM) 0 via a memory controller, and the processor 1 is configured to mount the dynamic random access memory 1 and the persistent memory 1 via the memory controller. In addition to accessing two local memory nodes via a local memory controller, one processor may also access the memory nodes mounted on the other processor via the ultra path interconnect (UPI) protocol. Moreover, the system is further provided with a non-uniform memory access (NUMA) framework, which enables unified management of the four memory nodes above. Of course, FIG. 1 illustrates only one possible hierarchical memory system. In other hierarchical memory systems, the number of processors, the number of memory nodes, and the mounting relationships between processors and memory nodes may vary.

In the system above, the rates of the processor to access the memory nodes vary due to memory performance and mounting relationships. For example, for the processor 0, the access latency and bandwidth conditions of the memory nodes are as follows: Accessing the dynamic random access memory 0 performs better than accessing the other three memory nodes, while accessing the persistent memory 0 is slower than accessing the dynamic random access memory 1. That is, for the processor 0, the performance ranking of the four memory nodes above is as follows: dynamic random access memory 0>dynamic random access memory 1>persistent memory 0>persistent memory 1. Therefore, to enable the hierarchical memory system to provide a high-performance service, the hierarchies corresponding to the memory nodes may be set according to the association relationship between the central processing unit and the memory nodes before the system provides the service. To better serve an application program thread, the hierarchies corresponding to the memory nodes may also be set according to a target central processing unit where the application program thread is located and an association relationship between the target central processing unit and the memory nodes. This process of setting the memory node hierarchy may occur during the application program initiation. The embodiments of the present disclosure do not define a specific association relationship. For example, the hierarchies corresponding to the memory nodes may be set according to the target central processing unit where the application program thread is located and the mounting relationship between the target central processing unit and the memory nodes. Alternatively, the hierarchies corresponding to the memory nodes may also be set according to the target central processing unit where the application program thread is located and the speed of the target central processing unit to read and write the memory nodes. Alternatively, the hierarchies corresponding to the memory nodes may also be set according to both the mounting relationship and the read-write speed. This may be set according to actual application requirements. Apparently, in the hierarchical memory system, a hierarchical relationship exists among the memory nodes. On this basis, to enable a local application program to access memory data quickly, a memory page required by an application program thread may usually be migrated to a memory node with better performance (i.e., upgrading the memory page to a memory node with a higher hierarchy), and this process is usually implemented by the non-uniform memory access framework. For example, for an application program thread running on the processor 0, since the dynamic random access memory 0 has the highest hierarchy and best performance for the thread, the framework will preferentially migrate the memory page from a lower-hierarchy memory node to the dynamic random access memory 0. However, the non-uniform memory access framework lacks a page downgrading mechanism, that is, a memory page can only be migrated from a lower-hierarchy memory node to a higher-hierarchy memory node, but the memory page cannot be migrated from the higher-hierarchy memory node to the lower-hierarchy memory node, which tends to result in the higher-hierarchy memory node being overwritten. For example, in the example above, such a defect may cause the dynamic random access memory 0 to be overwritten. When it is overwritten, the framework stops page migration and outputs page fault information without downgrading the memory pages in the dynamic random access memory 0 to actively reclaim space in the dynamic random access memory 0. Therefore, the related art has a defect that a memory page migration cannot be performed caused by the memory node being overwritten, thereby affecting an efficient operation of an application program. In view of above, the present disclosure may provide a memory data migration method, which can actively perform page downgrading on an inactive memory page in a target memory node when it is determined that the target memory node is about to be overwritten, so as to actively reclaim storage space in the memory node, thereby preventing the situation where the target memory node is overwritten and further solving the problem of being unable to migrate a memory page caused by the target memory node being overwritten.

It is to be noted that the embodiments of the present disclosure do not limit the hardware device for executing the method, which may include, for example, a personal computer, a server, etc.

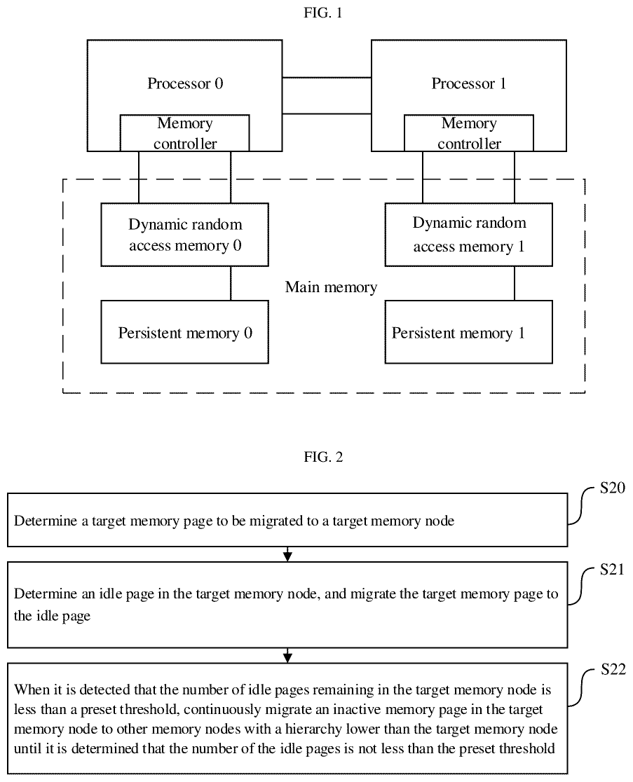

Referring to FIG. 2, FIG. 2 is a flowchart of a first memory data migration method according to an embodiment of the present disclosure. The method is applied to a hierarchical memory system which includes a plurality of memory nodes corresponding to different hierarchies. The method may include:

At S20, a target memory page to be migrated to a target memory node is determined.

Memory nodes typically store and manage data in units of pages, so data migration between memory nodes is also typically performed in units of pages. It is specifically noted that, in the embodiments of the present disclosure, a memory page refers to a page including memory data in a memory node, and memory page migration refers to the migration of memory data from one memory node to another in units of pages. It is to be understood that before performing memory page migration, the current location of the target memory page to be migrated and the target memory node to which it is to be migrated are first determined. The embodiments of the present disclosure do not limit the determination method above, and reference may be made to the relevant technology of a non-uniform memory access framework. For example, for a given application program thread, the target central processing unit (CPU) where the thread is located may first be determined, and a memory node with better performance for the processor may be set as the target memory node. For example, the memory node with the highest hierarchy and best performance may be set as the target memory node. Subsequently, when it is determined that the memory page requested to be accessed by the application program thread is not saved in the target memory node, the memory page may be set as the target memory page to be migrated to the target memory node.

On this basis, a target memory page is determined to be migrated to a target memory node may include:

At S2011, when it is determined that a memory page requested to be accessed by the application program thread is not saved in the target memory node, the memory page requested to be accessed by the application program thread is set as the target memory page.

At S21, an idle page in the target memory node is determined, and the target memory page is migrated to the idle page.

In the embodiments of the present disclosure, an idle page specifically refers to a page not including memory data in a memory node. It is to be understood that the target memory page is migrated to an idle page in the target memory node for access by the application program.

It is to be understood that after the migration of the target memory page is completed, the target memory node may be accessed to read the memory data in the target memory page and return the data to the application program thread for use by the application program thread.

On this basis, after the target memory page is migrated to the idle page, the method may further include:

At S211, data in the target memory page is returned to the application program thread.

At S22, when it is detected that the number of remaining idle pages in the target memory node is less than a preset threshold, an inactive memory page in the target memory node is continuously migrated to other memory nodes with a hierarchy lower than the target memory node until it is determined that the number of the idle pages is not less than the preset threshold.

To prevent the target memory node from being overwritten, the embodiments of the present disclosure may provide a page downgrading mechanism for the hierarchical memory system. Optionally, the embodiments of the present disclosure specifically set a preset threshold corresponding to the number of idle pages in the target memory node. The threshold for the number of idle pages is set, because the memory node typically stores and manages data in units of pages. When no idle pages are available in a memory node, it means that data cannot be written to the memory node. Therefore, the threshold provides a more accurate reflection of the remaining space in the memory node. However, during the process of memory page migration, the embodiments of the present disclosure update the number of remaining idle pages in real time. When it is determined that the number of remaining idle pages is less than a preset threshold, an inactive memory page in the target memory node is actively migrated to other memory nodes with a hierarchy lower than the target memory node, that is, the inactive memory page is actively downgraded to the lower-hierarchy memory node, wherein an inactive memory page refers to a memory page with lower activity and fewer recent accesses. Such downgrading process continues until it is determined that the number of idle pages is not less than the preset threshold. Apparently, since the embodiments of the present disclosure introduce a page downgrading mechanism, it is possible to prevent the target memory node from being overwritten, thereby preventing the defect of being unable to migrate a memory page to the target memory node caused by the target memory node being overwritten, and thus improving the operating efficiency of the application program.

It is to be noted that the embodiments of the present disclosure do not define a specific value for the preset threshold, which may be set according to practical application requirements. The embodiments of the present disclosure also do not define how to determine inactive memory pages. For example, the inactive memory pages may be determined on the basis of the number of accesses of the memory pages within a recent preset time period and may be determined by means of an inactive least recently used (LRU) linked list. The embodiments of the present disclosure do not define a specific execution method for migrating inactive memory pages to other memory nodes. For example, an inactive memory page may be migrated to the memory node with the lowest hierarchy and the worst performance. Alternatively, a corresponding relationship between the inactivity degree of a memory page and the hierarchy of the memory node may be preset, allowing the inactive memory page to be migrated to the memory node of the corresponding hierarchy on the basis of the inactivity degree of the inactive memory page.

It is to be noted that steps S21 and S22 may be performed in parallel, that is, while the memory page is migrated to the target memory node, the inactive memory page in the target memory node may also be synchronously downgraded to other memory nodes with a lower hierarchy, thereby preventing the page downgrading from affecting the page upgrading.

On the basis of the embodiments above, in the present disclosure, a target memory page to be migrated to a target memory node may be first determined; an idle page in the target memory node is determined, and the target memory page is migrated to the idle page; subsequently, when it is detected that the number of remaining idle pages in the target memory node is less than a preset threshold, an inactive memory page in the target memory node is continuously migrated to other memory nodes with a hierarchy lower than the target memory node until it is determined that the number of the idle pages is not less than the preset threshold. In other words, in the present disclosure, after each memory migration is completed, it is actively determined whether the remaining idle pages in the target memory node can meet the requirements for the next migration. If the remaining idle pages in the target memory node cannot meet the requirements for the next migration, the inactive memory page in the target memory node is actively migrated to other memory nodes with a hierarchy lower than the target memory node. This allows for the active page downgrading of the inactive memory page in the target memory node, thereby freeing up space in the target memory node, preventing the target memory node being overwritten, and facilitating efficient reading by the application program.

On the basis of the embodiments above, the two page downgrading methods according to the embodiments of the present disclosure will be described in detail below. In one possible case, the inactive memory page in the target memory node is migrated to the other memory nodes with the hierarchy lower than the target memory node may include:

At S2211, a preset corresponding relationship between an inactivity degree of a memory page and a hierarchy of a memory node is acquired.

In the embodiments of the present disclosure, the inactivity degree of the memory page may be quantified by the access amount thereof within the recent preset time period and is inversely proportional to the access amount, that is, the lower the access amount is, the higher the inactivity degree is. The embodiments of the present disclosure may set a plurality of threshold intervals for the access amount, each threshold interval corresponding to an inactivity degree. Subsequently, the embodiments of the present disclosure may set the corresponding relationship between the inactivity degree and the hierarchy of the memory node. Furthermore, when the inactive memory page is acquired, the embodiments of the present disclosure may downgrade the inactive memory page to other memory nodes of corresponding hierarchies according to an inactivity degree corresponding thereto.

At S2212, the inactive memory page is migrated to other memory nodes of corresponding hierarchies according to the preset corresponding relationship and the inactivity degree of the inactive memory page.

In another possible case, the inactive memory page in the target memory node is continuously migrated to the other memory nodes with the hierarchy lower than the target memory node may include:

At S2221, a first memory node with a slowest local access speed and a second memory node with a slowest remote access speed are determined from the other memory nodes.

In the embodiments of the present disclosure, the inactive memory page is migrated to the memory node with the slowest access speed to avoid the impact of the inactive memory page on the memory access. The memory node above may be the first memory node with the slowest local access speed for a local processor, for example, for the processor 0 in FIG. 1, the first memory node may be the persistent memory 0. The memory node may also be the second memory node with the slowest remote access speed, for example, for the processor 0 in FIG. 1, the second memory node may be the persistent memory 1.

At S2222, the inactive memory page in the target memory node is continuously migrated to the first memory node or the second memory node.

It is to be noted that no priority may be set between the first memory node and the second memory node, that is, inactive memory pages only need to be migrated to one of the two nodes above which has idle space. Of course, a priority may also be set between the two nodes above, such as preferentially migrating inactive memory pages to the second memory node and migrating same to the first memory node only when the second memory node is overwritten. The advantage of setting priorities is that inactive memory pages may be preferentially migrated to the slowest memory node for the local processor in the hierarchical memory system, thereby ensuring memory access efficiency. Of course, during memory page downgrading, if both the first memory node and the second memory node are overwritten, it is possible to cyclically determine whether the first memory node and the second memory node have idle space, and when it is determined that one of them has idle space again, to migrate the inactive memory page to it.

On this basis, the inactive memory page in the target memory node is continuously migrated to the first memory node or the second memory node may include:

At step 1, a target inactive memory page to be migrated currently is determined, and it is determined whether the second memory node is overwritten; if the second memory node has been overwritten, then proceed to step 3; if the second memory node is not overwritten, then proceed to step 2.

At step 2, the target inactive memory page is migrated to the second memory node.

At step 3, it is determined whether the first memory node is overwritten; if the first memory node has been overwritten, then proceed to step 5; if the first memory node is not overwritten, then proceed to step 4.

At step 4, a target inactive memory page is migrated to a first memory node.

At step 5, it proceeds to the step of determining whether the second memory node is overwritten.

It is to be noted that for a remotely accessed memory node, the local processor may migrate, on the basis of an ultra path interconnect protocol, the inactive memory page in the target memory node to the second memory node.

On the basis of the embodiments above, the specific manner in which inactive memory pages are distinguished is described in detail below. On this basis, continuously migrating the inactive memory page in the target memory node to the other memory nodes with the hierarchy lower than the target memory node may include:

At S2231, a memory page with a least access amount within a recent preset time period is set as the inactive memory page.

The embodiments of the present disclosure may set the memory page with the least access amount within the recent preset time period as the inactive memory page, wherein the preset time period may be arbitrarily set according to practical application requirements. It may be understood that since only one inactive memory page is determined at a time, after the downgrading of the inactive memory page is completed, the embodiments of the present disclosure need to update the number of idle pages and determine whether the updated number of idle pages is less than a preset threshold. If the updated number of idle pages is still less than the preset threshold, the embodiments of the present disclosure need to continue to determine the next inactive memory page, and downgrade the next inactive memory page until it is determined that the updated number of idle pages is not less than the preset threshold.

It is to be noted that the embodiments of the present disclosure do not define how to search for the memory page with the least access amount within the recent preset time period. For example, the number of accesses to the memory pages may be counted voluntarily, or the determination may be made on the basis of an existing inactive least recently used (LRU) linked list, and the memory page at the end of the linked list may be directly set as the inactive memory page.

On this basis, a memory page with a least access amount within a recent preset time period is set as the inactive memory page may include:

At S22311, the memory page with the least access amount within the recent preset time period is set, using an inactive least recently used linked list, as the inactive memory page.

It is to be noted that in the Linux operating system, the memory may be divided into file pages and anonymous pages. The operating system may use a plurality of least recently used linked lists to record recent access to the file pages and anonymous pages, such as an active file page least recently used linked list, an inactive file page least recently used linked list, an active anonymous page least recently used linked list, and an inactive anonymous page least recently used linked list. The inactive least recently used linked list may be used to determine the page with the least access amount. In some embodiments, the inactive file page least recently used linked list is searched first, and the page at the tail of the linked list is selected as the page to be downgraded. If the inactive file page least recently used linked list is empty, the inactive anonymous page least recently used linked list is searched, and the page at the tail of the linked list is selected as the page with the least recent access amount.

On this basis, the memory page with the least access amount within the recent preset time period is set, using an inactive least recently used linked list, as the inactive memory page may include:

At step 1, when it is determined that an inactive file page least recently used linked list is not empty, a memory page at a tail of the inactive file page least recently used linked list is set as the inactive memory page.

At step 2, when it is determined that the inactive file page least recently used linked list is empty, a memory page at a tail of an inactive anonymous page least recently used linked list is set as the inactive memory page.

At S2232, the inactive memory page is migrated to the other memory nodes, and the number of the idle pages is updated.

At S2233, when it is determined that the updated number of the idle pages is less than the preset threshold, it proceeds to the step of setting a memory page with a least access amount within a recent preset time period as the inactive memory page.

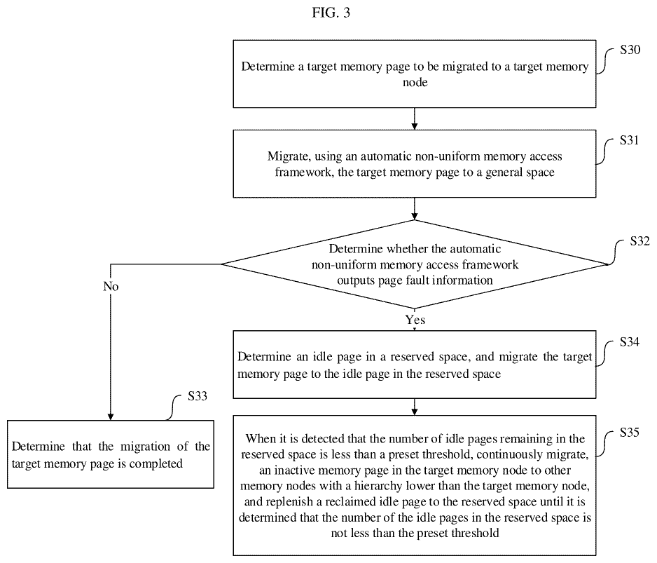

On the basis of the embodiments above, in the present disclosure, a storage space in a target memory node may also be divided into a general space and a reserved space and maintained by an automatic non-uniform memory access (AutoNUMA) framework, and a page downgrading mechanism is set on the basis of the reserved space, to provide a page downgrading function for the hierarchical memory system without affecting the existing mechanism of the automatic non-uniform memory access framework. Referring to FIG. 3, FIG. 3 is a flowchart of a second memory data migration method according to an embodiment of the present disclosure. The method may further include:

At S30, a target memory page to be migrated to a target memory node is determined; a storage space of the target memory node includes a general space and a reserved space, the general space being maintained by an automatic non-uniform memory access framework.

In the embodiments of the present disclosure, the target memory node has been divided into a general space and a reserved space, wherein the general space may be maintained by an automatic non-uniform memory access framework which is a non-uniform memory access framework in the Linux operating system, and the reserved space is used for setting the page downgrading mechanism according to the embodiments of the present disclosure.

At S31, the target memory page is migrated, using the automatic non-uniform memory access framework, to the general space.

At S32, it is determined whether the automatic non-uniform memory access framework outputs page fault information; if the automatic non-uniform memory access framework has output the page fault information, then proceed to S34; and if the automatic non-uniform memory access framework does not output the page fault information, then proceed to S33.

In some embodiments, upon migrating the target memory page, the embodiments of the present disclosure may first submit the target memory page to the automatic non-uniform memory access framework for processing. The framework may attempt to migrate the target memory page above into the general space, complete the migration when it is determined that there is an idle page in the general space, and stop the migration when it is determined that there is no idle page in the general space, and output page fault information. Subsequently, the embodiments of the present disclosure only need to determine whether the framework has output page fault information, upon which the memory page downgrading mechanism provided by the embodiments of the present disclosure may be triggered.

At S33, it is determined that the migration of the target memory page is completed.

At S34, an idle page in the reserved space is determined, and the target memory page is migrated to the idle page in the reserved space.

Upon determining that the general space of the target memory node is overwritten, the embodiments of the present disclosure may enable the reserved space and determine an idle page in the reserved space, thereby migrating the target memory page to the idle page in the reserved space. It is to be noted that since the page fault information output by the automatic non-uniform memory access framework already includes the location of the target memory page, the embodiments of the present disclosure only need to migrate the target memory page to the reserved space according to the page fault information.

On this basis, migrating the target memory page to the idle page in the reserved space may include:

At S3411, a location of the target memory page is determined according to the page fault information.

At S3412, the target memory page is migrated, according to the location, to the idle page in the reserved space.

At S35, when it is detected that the number of remaining idle pages in the reserved space is less than the preset threshold, the inactive memory page in the target memory node is continuously migrated to the other memory nodes with the hierarchy lower than the target memory node, and a reclaimed idle page is replenished to the reserved space until it is determined that the number of the idle pages in the reserved space is not less than the preset threshold.

Since the page downgrading mechanism is set on the basis of the reserved space, while performing target memory page migration, the embodiments of the present disclosure may detect in real time whether the number of remaining idle pages in the reserved space is less than the preset threshold; when it is determined that the number is less than the preset threshold, the inactive memory page in the target memory node is continuously migrated to the other memory nodes with the hierarchy lower than the target memory node, a reclaimed idle page is replenished to the reserved space until it is determined that the number of the idle pages in the reserved space is not less than the preset threshold, and the memory page downgrading is stopped. With the arrangement above, the embodiments of the present disclosure may provide a page downgrading mechanism for the hierarchical memory system without intruding into the automatic non-uniform memory access framework, while enabling the mechanism to run in parallel with the existing mechanism in the automatic non-uniform memory access framework.

It is to be noted that for the migration of the target memory page and page downgrading, the embodiments of the present disclosure may also set corresponding threads for processing. The migration of the target memory page may be executed by a first preset thread, and the page downgrading of the inactive memory page may be executed by a second preset thread. The second preset thread may run independently as a background thread to avoid interfering with the migration of the target memory page. This enables the migration of the target memory page and page downgrading to run in parallel, thereby improving processing efficiency.

On this basis, determining an idle page in the reserved space, and migrating the target memory page to the idle page in the reserved space may include:

At S3421, the idle page in the reserved space is determined using a first preset thread, and the target memory page is migrated to the idle page in the reserved space.

Accordingly, the inactive memory page in the target memory node is continuously migrated to the other memory nodes with the hierarchy lower than the target memory node, and a reclaimed idle page is replenished to the reserved space may include:

At S3511, the inactive memory page in the target memory node is continuously migrated, using a second preset thread, to the other memory nodes, and the reclaimed idle page is replenished to the reserved space.

To conserve resources, the first preset thread above may also detect whether the number of remaining idle pages in the reserved space is less than a preset threshold, and when it is determined that the number of remaining idle pages in the reserved space is less than the preset threshold, may wake up the preset thread above to initiate the page downgrading mechanism.

On this basis, the method may further include:

At S3521, the second preset thread is waked up using the first preset thread, when the first preset thread determines that the number of the remaining idle pages in the reserved space is less than the preset threshold.

Moreover, to conserve resources, the embodiments of the present disclosure may also automatically hibernate the second preset thread above when it is determined that the number of remaining idle pages in the reserved space is not less than the preset threshold. In other words, the second preset thread is activated only when the number of remaining idle pages in the reserved space is less than the preset threshold, preventing the page downgrading mechanism from constantly running in the background, thereby conserving resources effectively.

On this basis, the method may further include:

At S3531, the second preset thread is hibernated when it is determined that the number of the idle pages in the reserved space is not less than the preset threshold.

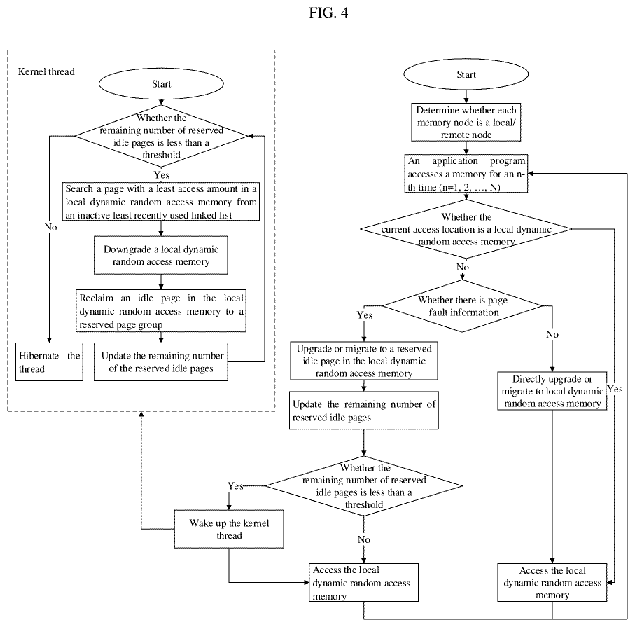

The memory data migration method above is described in detail below on the basis of another flowchart. Referring to FIG. 4, FIG. 4 is a flowchart of a third memory data migration method according to an embodiment of the present disclosure. The method may include:

At step 1, an application program is initiated, and it is determined whether each memory node is a local node or a remote node according to the location of a central processing unit where an application program thread is located, that is, the identities of the nodes are determined, including a local dynamic random access memory, a remote dynamic random access memory, a local persistent memory, and a remote persistent memory.

At step 2, the application program accesses the memory, and determines whether the current access location is in the local dynamic random access memory; if the current access location is in the local dynamic random access memory, then the local dynamic random access memory is directly accessed; and if the current access location is not in the local dynamic random access memory, the process proceeds to step 3.

At step 3, it is searched for page fault information from the automatic non-uniform memory access framework (AutoNUMA); if the automatic non-uniform memory access framework has no page fault information, it indicates that the local dynamic random access memory is not overwritten, allowing direct upgrading or migration to the local dynamic random access memory, followed by accessing the local dynamic random access memory; and if the automatic non-uniform memory access framework has page fault information, it indicates that the local dynamic random access memory is overwritten, and it proceeds to step 4.

At step 4, according to the location of the fault page (i.e., the location to be currently accessed), the fault page is upgraded or migrated to a reserved idle page in the local dynamic random access memory, and the number of reserved idle pages in the local dynamic random access memory is updated.

At step 5, it is determined whether the number of reserved idle pages is less than a preset threshold. If the number of reserved idle pages is greater than or equal to the preset threshold, the upgraded or migrated memory page data in the local dynamic random access memory is accessed. If the number of reserved idle pages is less than the preset threshold, the kernel thread is waked up before accessing the upgraded or migrated memory page data in the local dynamic random access memory.

After being woken up, the kernel thread runs independently as a background thread. The specific execution process is as follows: the memory page with the least access amount in the recent period is searched from the inactive least recently used linked list, and is downgraded, and then the idle pages in the local dynamic random access memory is reclaimed to the reserved page group until the number of reserved idle pages is not less than the threshold.

The memory data migration apparatus, electronic device, and non-transitory computer readable storage medium according to the embodiments of the present disclosure are described below. The following descriptions of the memory data migration apparatus, electronic device, and non-transitory computer readable storage medium may be correspondingly referred to the memory data migration method described above.

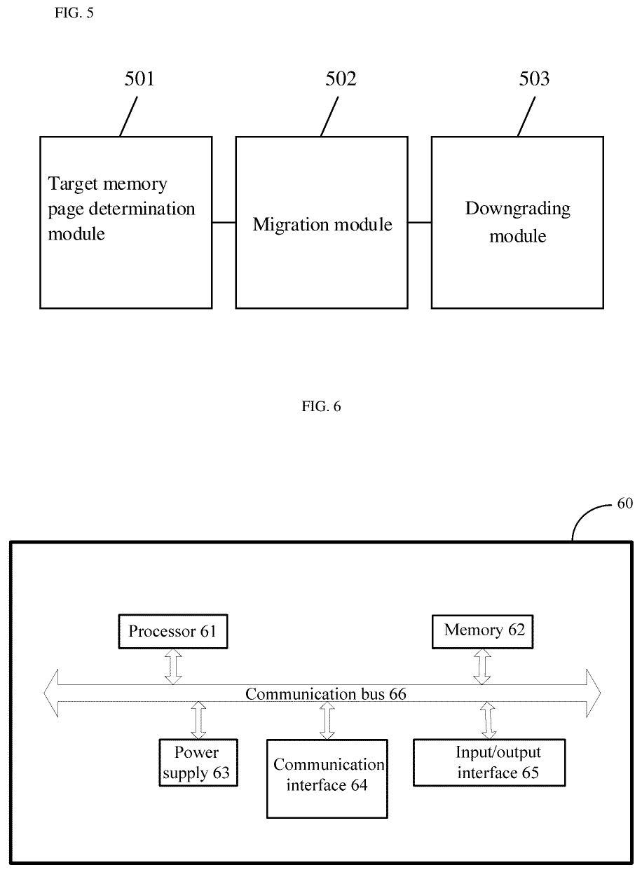

Referring to FIG. 5, FIG. 5 is a structural block diagram of a memory data migration apparatus according to an embodiment of the present disclosure. The apparatus is applied to a hierarchical memory system, wherein the hierarchical memory system includes a plurality of memory nodes corresponding to different hierarchies, and the apparatus includes:
a target memory page determination module 501, configured to determine a target memory page to be migrated to a target memory node;
a migration module 502, configured to determine an idle page in the target memory node, and migrate the target memory page to the idle page; and
a downgrading module 503, configured to continuously migrate, when it is detected that the number of remaining idle pages in the target memory node is less than a preset threshold, an inactive memory page in the target memory node to other memory nodes with a hierarchy lower than the target memory node until it is determined that the number of the idle pages is not less than the preset threshold.

In some embodiments, the downgrading module 503 may include:
a node selection sub-module, configured to determine a first memory node with a slowest local access speed and a second memory node with a slowest remote access speed from the other memory nodes; and
a downgrading sub-module, configured to continuously migrate the inactive memory page in the target memory node to the first memory node or the second memory node.

In some embodiments, the downgrading sub-module may include:
a first determination unit, configured to determine a target inactive memory page to be migrated currently, and determine whether the second memory node is overwritten;
a first migration unit, configured to migrate, in response to the first determination unit determining that the second memory node is not overwritten, the target inactive memory page to the second memory node;
a second determination unit, configured to determine, in response to the first determination unit determining that the second memory node is overwritten, whether a first memory node is overwritten; and recall, in response to the first memory node being overwritten, the first determination unit to execute the step of determining whether the second memory node is overwritten; and
a second migration unit, configured to migrate, in response to the second determination unit determining that the first memory node is not overwritten, the target inactive memory page to the first memory node.

In some embodiments, the downgrading sub-module is configured to:
migrate, on the basis of an ultra path interconnect protocol, the inactive memory page in the target memory node to the second memory node.

In some embodiments, the downgrading module 503 may include:
an acquisition sub-module, configured to acquire a preset corresponding relationship between an inactivity degree of a memory page and a hierarchy of a memory node; and
a downgrading sub-module, configured to migrate, according to the preset corresponding relationship and the inactivity degree of the inactive memory page, the inactive memory page to other memory nodes of corresponding hierarchies.

In some embodiments, the downgrading module 503 may include:
an inactive memory page setting sub-module, configured to set a memory page with a least access amount within a recent preset time period as the inactive memory page;
a migration sub-module, configured to migrate the inactive memory page to the other memory nodes, and update the number of the idle pages; and
a circulation sub-module, configured to call, when it is determined that the updated number of idle pages is less than the preset threshold, the inactive memory page setting sub-module to proceed to the step of setting a memory page with a least access amount within a recent preset time period as the inactive memory page.

In some embodiments, the inactive memory page setting sub-module is configured to:
set, using an inactive least recently used linked list, the memory page with the least access amount within the recent preset time period as the inactive memory page.

In some embodiments, the inactive memory page setting sub-module may include:
a first setting unit, configured to set, when it is determined that an inactive file page least recently used linked list is not empty, a memory page at a tail of the inactive file page least recently used linked list as the inactive memory page; and
a second setting unit, configured to set, when it is determined that the inactive file page least recently used linked list is empty, a memory page at a tail of an inactive anonymous page least recently used linked list as the inactive memory page.

In some embodiments, the apparatus may further include:
a memory node hierarchy setting module, configured to set, according to a target central processing unit where an application program thread is located and an association relationship between the target central processing unit and the memory nodes, hierarchies corresponding to the memory nodes.

In some embodiments, the memory node hierarchy setting module is configured to:
set, according to the target central processing unit where the application program thread is located and a mounting relationship between the target central processing unit and the memory nodes, the hierarchies corresponding to the memory nodes.

In some embodiments, the memory node hierarchy setting module is configured to:
set, according to the target central processing unit where the application program thread is located and a speed of the target central processing unit to read and write the memory nodes, the hierarchies corresponding to the memory nodes.

In some embodiments, the apparatus may further include:
a target memory node setting module, configured to set a memory node with a highest hierarchy as the target memory node.

In some embodiments, the target memory page determination module 501 is configured to:
when it is determined that a memory page requested to be accessed by the application program thread is not saved in the target memory node, set the memory page requested to be accessed by the application program thread as the target memory page.

In some embodiments, the apparatus may further include:
a data return module, configured to return data in the target memory page to the application program thread.

In some embodiments, a storage space of the target memory node includes a general space and a reserved space, the general space being maintained by an automatic non-uniform memory access framework; and the migration module 502 may include:
a first migration sub-module, configured to migrate, using the automatic non-uniform memory access framework, the target memory page to the general space, and determine whether the automatic non-uniform memory access framework outputs page fault information; and
a second migration sub-module, configured to determine, in response to the automatic non-uniform memory access framework having output the page fault information, an idle page in the reserved space, and migrate the target memory page to the idle page in the reserved space.

Accordingly, the downgrading module 503 is configured to:
when it is detected that the number of remaining idle pages in the reserved space is less than the preset threshold, continuously migrate, the inactive memory page in the target memory node to the other memory nodes with the hierarchy lower than the target memory node, and replenish a reclaimed idle page to the reserved space until it is determined that the number of the idle pages in the reserved space is not less than the preset threshold.

In some embodiments, the second migration sub-module may include:
a target memory page reading unit, configured to determine, according to the page fault information, a location of the target memory page; and
a migration unit, configured to migrate, according to the location, the target memory page to the idle page in the reserved space.

In some embodiments, the second migration sub-module is configured to:
determine, using a first preset thread, the idle page in the reserved space, and migrate the target memory page to the idle page in the reserved space; and

Accordingly, the downgrading module 503 is configured to:
continuously migrate, using a second preset thread, the inactive memory page in the target memory node to the other memory nodes, and replenish the reclaimed idle page to the reserved space.

In some embodiments, the apparatus may further include:
a thread wake-up module, configured to wake up, when the first preset thread determines that the number of the remaining idle pages in the reserved space is less than the preset threshold, the second preset thread using the first preset thread.

In some embodiments, the apparatus may further include:
a thread hibernation module, configured to hibernate, when it is determined that the number of the idle pages in the reserved space is not less than the preset threshold, the second preset thread.

Referring to FIG. 6, FIG. 6 is a structural block diagram of an electronic device according to an embodiment of the present disclosure. The embodiments of the present disclosure provide an electronic device 60, including a processor 61 and a memory 62, wherein the memory 62 is configured to store a computer program, and the processor 61 is configured to perform, when executing the computer program, the memory data migration method according to the embodiments above.

The specific process of the memory data migration method above may be referred to the corresponding contents according to the embodiments above, and the description thereof will not be repeated here.

Furthermore, the memory 62, as a carrier for resource storage, may be a read-only memory, random access memory, magnetic disk, optical disk, or the like. The storage may be either transient or permanent.

In addition, the electronic device 60 further includes a power supply 63, a communication interface 64, an input/output interface 65, and a communication bus 66. The power supply 63 is configured to supply an operating voltage to each hardware devices of the electronic device 60. The communication interface 64 can establish a data transmission channel between the electronic device 60 and an external device, following any communication protocol applicable to the technical solution of the present disclosure, without specific limitations herein. The input/output interface 65 is configured to receive external input data or output data to external devices, with its interface type selectable on the basis of specific application requirements, without specific limitations herein.

The embodiments of the present disclosure further provide a non-transitory computer readable storage medium storing a computer program thereon that, when executed by a processor, performs the steps of the memory data migration method according to any one of the embodiments described above.

Since the embodiments of the non-transitory computer readable storage medium section correspond to the embodiments of the memory data migration method section, the embodiments of the non-transitory readable storage medium section may be referred to the description of the embodiments of the memory data migration method section and will not be repeated again.

The embodiments are described in the description progressively, with each embodiment focusing on differences from the other embodiments, and with reference to the same or similar parts of the embodiments. The apparatus disclosed in the embodiments is relatively simple to describe since it corresponds to the method disclosed in the embodiments, as explained in the method section.

The skilled may be aware that the units and algorithmic steps of each embodiment described in conjunction with the embodiments disclosed herein may be implemented in electronic hardware, computer software, or a combination thereof, and that the composition and steps of each embodiment have been described generally by function in the description above to clearly illustrate the interchangeability of hardware and software. Whether such functions are implemented as hardware or software depends upon the particular application and design constraints imposed on the technical solutions. Those skilled in the art may implement the described functions in varying ways for each particular application, but such implementation should not be interpreted as departing from the scope of the present disclosure.

The steps of the methods or algorithms described in combination with the embodiments disclosed herein may be implemented directly with hardware and a software module executed by the processor, or a combination thereof. The software module may be arranged in a random access memory (RAM), a memory, a read-only memory (ROM), an electrically programmable ROM, an electrically erasable programmable ROM, a register, a hard disk, a removable magnetic disk, a CD-ROM, or any other form of non-transitory readable storage medium known in the art.

The above is a detailed introduction to a memory data migration method and apparatus, an electronic device, and a storage medium according to the present disclosure. Specific examples are applied herein to illustrate the principle and embodiments of the present disclosure. The embodiments above are only used to help understand the method and core ideas of the present disclosure. For a person of ordinary skill in the art, without deviating from the principle of the present disclosure, several improvements and modifications may also be made to the present disclosure, and these improvements and modifications also fall within the scope of protection of the claims of the present disclosure.

1. A memory data migration method, applied to a hierarchical memory system, wherein the hierarchical memory system comprises a plurality of memory nodes corresponding to different hierarchies, and the method comprises:
determining a target memory page to be migrated to a target memory node;
determining an idle page in the target memory node, and migrating the target memory page to the idle page; and
when it is detected that the number of remaining idle pages in the target memory node is less than a preset threshold, continuously migrating an inactive memory page in the target memory node to other memory nodes with a hierarchy lower than the target memory node until it is determined that the number of the idle pages is not less than the preset threshold.

2. The memory data migration method according to claim 1, wherein continuously migrating the inactive memory page in the target memory node to other memory nodes with the hierarchy lower than the target memory node comprises:
determining a first memory node with a slowest local access speed and a second memory node with a slowest remote access speed from the other memory nodes; and
continuously migrating the inactive memory page in the target memory node to the first memory node or the second memory node.

3. The memory data migration method according to claim 2, wherein continuously migrating the inactive memory page in the target memory node to the first memory node or the second memory node comprises:
determining a target inactive memory page to be migrated currently, and determining whether the second memory node is overwritten;
migrating, in response to the second memory node being not overwritten, the target inactive memory page to the second memory node;
determining, in response to the second memory node being overwritten, whether the first memory node is overwritten;
migrating, in response to the first memory node being not overwritten, the target inactive memory page to the first memory node; and
proceeding to, in response to the first memory node being overwritten, the step of determining whether the second memory node is overwritten.

4. The memory data migration method according to claim 2, wherein migrating the inactive memory page in the target memory node to the second memory node comprises:
migrating, on the basis of an ultra path interconnect protocol, the inactive memory page in the target memory node to the second memory node.

5. The memory data migration method according to claim 1, wherein migrating the inactive memory page in the target memory node to other memory nodes with the hierarchy lower than the target memory node comprises:
acquiring a preset corresponding relationship between an inactivity degree of a memory page and a hierarchy of a memory node; and
migrating, according to the preset corresponding relationship and the inactivity degree of the inactive memory page, the inactive memory page to other memory nodes of corresponding hierarchies.

6. The memory data migration method according to claim 1, wherein continuously migrating the inactive memory page in the target memory node to other memory nodes with the hierarchy lower than the target memory node comprises:
setting a memory page with a least access amount within a recent preset time period as the inactive memory page;
migrating the inactive memory page to the other memory nodes, and updating the number of the idle pages; and
when it is determined that the updated number of the idle pages is less than the preset threshold, proceeding to the step of setting a memory page with a least access amount within a recent preset time period as the inactive memory page.

7. The memory data migration method according to claim 6, wherein setting the memory page with the least access amount within the recent preset time period as the inactive memory page comprises:
setting, using an inactive least recently used linked list, the memory page with the least access amount within the recent preset time period as the inactive memory page.

8. The memory data migration method according to claim 7, wherein setting, using the inactive least recently used linked list, the memory page with the least access amount within the recent preset time period as the inactive memory page comprises:
when it is determined that an inactive file page least recently used linked list is not empty, setting a memory page at a tail of the inactive file page least recently used linked list as the inactive memory page; and
when it is determined that the inactive file page least recently used linked list is empty, setting a memory page at a tail of an inactive anonymous page least recently used linked list as the inactive memory page.

9. The memory data migration method according to claim 1, wherein before determining the target memory page to be migrated to a target memory node, the memory data migration method further comprises:
setting, according to a target central processing unit where an application program thread is located and an association relationship between the target central processing unit and the memory nodes, hierarchies corresponding to the memory nodes.

10. The memory data migration method according to claim 9, wherein setting, according to the target central processing unit where an application program thread is located and the association relationship between the target central processing unit and the memory nodes, hierarchies corresponding to the memory nodes comprises:
setting, according to the target central processing unit where the application program thread is located and a mounting relationship between the target central processing unit and the memory nodes, the hierarchies corresponding to the memory nodes.

11. The memory data migration method according to claim 9, wherein setting, according to the target central processing unit where the application program thread is located and the association relationship between the target central processing unit and the memory nodes, hierarchies corresponding to the memory nodes comprises:
setting, according to the target central processing unit where the application program thread is located and a speed of the target central processing unit to read and write the memory nodes, the hierarchies corresponding to the memory nodes.

12. The memory data migration method according to claim 9, wherein after setting the hierarchies corresponding to the memory nodes, the memory data migration method further comprises:
setting a memory node with a highest hierarchy as the target memory node.

13. The memory data migration method according to claim 9, wherein determining the target memory page to be migrated to the target memory node comprises:
when it is determined that a memory page requested to be accessed by the application program thread is not saved in the target memory node, setting the memory page requested to be accessed by the application program thread as the target memory page.

14. The memory data migration method according to claim 12, after migrating the target memory page to the idle page, the memory data migration method further comprises:
returning data in the target memory page to the application program thread.

15. The memory data migration method according to claim 1, wherein a storage space of the target memory node comprises a general space and a reserved space, wherein the general space is maintained by an automatic non-uniform memory access framework; and determining the idle page in the target memory node, and migrating the target memory page to the idle page comprises:
migrating, using the automatic non-uniform memory access framework, the target memory page to the general space, and determining whether the automatic non-uniform memory access framework outputs page fault information; and
determining, in response to the automatic non-uniform memory access framework having output the page fault information, an idle page in the reserved space, and migrating the target memory page to the idle page in the reserved space; and
accordingly, when it is detected that the number of remaining idle pages in the target memory node is less than a preset threshold, continuously migrating an inactive memory page in the target memory node to other memory nodes with a hierarchy lower than the target memory node until it is determined that the number of the idle pages is not less than the preset threshold comprises:
when it is detected that the number of remaining idle pages in the reserved space is less than the preset threshold, continuously migrating the inactive memory page in the target memory node to the other memory nodes with the hierarchy lower than the target memory node, and replenishing a reclaimed idle page to the reserved space until it is determined that the number of the idle pages in the reserved space is not less than the preset threshold.

16. The memory data migration method according to claim 15, wherein migrating the target memory page to the idle page in the reserved space comprises:
determining, according to the page fault information, a location of the target memory page; and
migrating, according to the location, the target memory page to the idle page in the reserved space.

17. The memory data migration method according to claim 15, wherein determining the idle page in the reserved space, and migrating the target memory page to the idle page in the reserved space comprises:
determining, using a first preset thread, the idle page in the reserved space, and migrating the target memory page to the idle page in the reserved space; and
accordingly, continuously migrating the inactive memory page in the target memory node to the other memory nodes with the hierarchy lower than the target memory node, and replenishing a reclaimed idle page to the reserved space comprises:
continuously migrating, using a second preset thread, the inactive memory page in the target memory node to the other memory nodes, and replenishing the reclaimed idle page to the reserved space.

18. The memory data migration method according to claim 17, further comprising:
when the first preset thread determines that the number of the remaining idle pages in the reserved space is less than the preset threshold, waking up, using the first preset thread, the second preset thread;
further comprising:
when it is determined that the number of the idle pages in the reserved space is not less than the preset threshold, hibernating the second preset thread.

19-20. (canceled)

21. An electronic device, comprising:
a memory, configured to store a computer program; and
a processor, configured to implement, when executing the computer program, the computer program instructions implement to:
determine a target memory page to be migrated to a target memory node;
determine an idle page in the target memory node, and migrating the target memory page to the idle page; and
when it is detected that the number of remaining idle pages in the target memory node is less than a preset threshold, continuously migrating an inactive memory page in the target memory node to other memory nodes with a hierarchy lower than the target memory node until it is determined that the number of the idle pages is not less than the preset threshold

22. A non-transitory computer readable storage medium storing therein a computer-executable instruction that, when loaded and executed by a processor, wherein the processor, in a case of executing the computer program, the computer program instructions implement to:
determine a target memory page to be migrated to a target memory node;
determine an idle page in the target memory node, and migrating the target memory page to the idle page; and
when it is detected that the number of remaining idle pages in the target memory node is less than a preset threshold, continuously migrating an inactive memory page in the target memory node to other memory nodes with a hierarchy lower than the target memory node until it is determined that the number of the idle pages is not less than the preset threshold.
